(19) United States
(12) Patent Application Publication
(10) Pub. No.: US 2013/0113277 A1
(43) Pub. Date: May 9, 2013

(54) BATTERY MANAGEMENT SYSTEM AND METHOD OF VEHICLE

(71) Applicants: Sung Tae Kim, Yongin (KR); Seungpyo Lee, Hwaseong (KR); Jung Ho Yoon, Seoul (KR)

(72) Inventors: Sung Tae Kim, Yongin (KR); Seungpyo Lee, Hwaseong (KR); Jung Ho Yoon, Seoul (KR)

(73) Assignees: KIA MOTORS CORPORATION, Seoul (KR); HYUNDAI MOTOR COMPANY, Seoul (KR)

(21) Appl. No.: 13/492,001

(22) Filed: Jun. 8, 2012

(30) Foreign Application Priority Data
Nov. 3, 2011 (KR) 10-2011-0114079

(51) Int. Cl. B60L 1/00

(52) U.S. Cl. 307/9.1

(57) ABSTRACT

Disclosed is a battery management system. More specifically, the battery management system includes an alternator that supplies a battery and electronic equipment of a vehicle with electricity that is generated by a driving torque of the vehicle, a battery that supplies the electronic equipment with power that is charged by the alternator, a battery observer that observes a condition of the battery, a vehicle information collection portion that collects vehicle condition information according to driving of the vehicle, and a control portion that performs charging recovery of the battery by activating a battery refresh operation when at least one condition of a current accumulation value of the battery, a low SCO entry frequency, and a vehicle starting frequency satisfies a predetermined battery refresh condition.

### CROSS-REFERENCE TO RELATED APPLICATION

This application claims priority to and the benefit of Korean Patent Application No. 10-2011-0114079 filed in the Korean Intellectual Property Office on Nov. 3, 2011, the entire contents of which are incorporated herein by reference.

### BACKGROUND OF THE INVENTION

(a) Field of the Invention

The present invention relates to a vehicle battery management system and the method thereof.

(b) Description of the Related Art

Generally, a vehicle includes a battery that supplies electrical power to electronic devices within the vehicle, and an alternator that generates electrical power to supply the battery and the electronic devices with generated power. Due to growing concerns regarding energy efficiency and environmental effects, environmentally friendly vehicles which use a high voltage battery as an energy source such as a hybrid vehicle (HEV) and an electric vehicle (EV) have become popular alternatives to the traditional internal combustion engine.

These high voltage batteries, however, must be frequently charged and discharged over a predetermined range, and the lifespan of the battery is reduced due deep cycling (significant discharging). Also, the charging/discharging capacity of the battery is deteriorated due to a memory effect of the battery.

FIG. 1 is a graph showing a lifespan influence according to a charging/discharging characteristic of a conventional battery.

Referring to FIG. 1, Case #1 shows a condition in which the battery is dead after a short period of time (t) because the battery is not charged. This case can also occur when the charging/discharging balance of the battery is abnormally set, or the lifespan reduction in a normal condition is caused by endurance deterioration, however, the above case can be thought of as the battery going dead due to a simple discharge.

Case #2 shows a condition in which the capacity of the battery is reduced by controlling a state of charge (SOC) of the battery in a predetermined area. That is, the charging/discharging balance for the battery is sufficient, but the battery is not fully charged because of insufficient charging efficiency thereof. Accordingly, when these conditions are repeatedly performed, the charging capacity of the battery is often reduced over time (t).

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a vehicle battery management system and a method thereof having advantages of preventing capacity reduction of a battery and improving durability thereof by periodically performing battery charging recovery according to the condition of the battery.

A vehicle battery management system according to an exemplary embodiment of the present invention may include an alternator that supplies a battery and electronic equipment of a vehicle with electricity that is generated by a driving torque of the vehicle, a battery that supplies the electronic equipment with power that is charged by the alternator, a battery observer that observes a condition of the battery, a vehicle information collection portion that collects vehicle condition information based on how the vehicle is being driven, and a control portion that performs charging recovery of the battery by activating a battery refresh operation when at least one condition of a current accumulation value of the battery, a low SCO entry frequency, and a vehicle starting frequency satisfies a predetermined battery refresh condition.

The vehicle battery management system may further include a storage portion, such as a memory or a storage device, that stores a predetermined threshold condition and condition information related to the vehicle and the battery to be able to determine whether the battery satisfies a refresh condition.

The battery observer may include at least one of an accumulation current measure module that accumulates values of charged current and discharged current of the battery to calculate a current accumulation value of the charged current and the discharged current, and a low SOC counter module that observes an SOC (state of charge) of the battery and counts a frequency of the charging state of the battery entering into a predetermined low charging state (low SOC).

The vehicle information collection portion may collect a vehicle speed and an engine revolutions per minute (RPM) according to the operation of the vehicle and may count the starting frequency of the vehicle.

The control portion may deactivate a control command when the battery is recovering in a charging state. The electricity that is generated by the alternator in this scenario is all focused on the battery charging recovery. In this case, the control portion may perform the charging recovery until the charging state of the battery exceeds a predetermined recovery threshold.

In some exemplary embodiments of the present invention, the control portion may perform the charging recovery of the battery for a predetermined time, when the amount of electricity generated by the alternator, the battery voltage, and the battery current value satisfy the predetermined conditions.

The control portion may deactivate the battery refresh operation when the charging recovery of the battery has completed, and then reset the battery current accumulation value, the low SOC entry frequency, and the vehicle starting frequency.

In accordance with an exemplary embodiment of the present invention, a vehicle battery management method that is performed by a system that includes an alternator of a vehicle, a battery, and a control portion managing a charging state of the battery may include a) collecting, by a controller, condition information of the vehicle and a condition of the battery, b) determining, by the controller, whether at least one condition of a current accumulation value of the battery, a low SCO entry frequency, and a vehicle starting frequency satisfies a predetermined battery refresh condition, and c) performing, by the controller, charging recovery of the battery by activating the battery refresh operation, when the determination result satisfies the battery refresh condition.

In some embodiments of the present invention, determining whether at least one condition has been met may include b-1) determining that the refresh condition is satisfied when the current accumulation value of the charging and discharging current of the battery exceeds a predetermined value, b-2) determining that the refresh operating condition is satisfied in a case that the frequency of entering into a lowest SOC of the battery exceeds a predetermined threshold, and b-3) determining that that the refresh operating condition is satisfied in a case that the starting frequency of the vehicle exceeds a predetermined threshold.

Performing charging recovery of the battery may include deactivating the generation control and activating the battery refresh, when the vehicle speed and the engine RPMs satisfy a predetermined condition at which the alternator can generate electricity.

Step c) may also include operating the charging recovery until the charging state of the battery exceeds a predetermined recovery threshold, or performing the charging recovery of the battery for a predetermined time in a condition in which the generating amount of the alternator, battery voltage, and battery current value satisfy a predetermined condition.

After step c), the frequency at which the refresh performance result of the battery does not exceed a recovery threshold may be counted and stored, and when the stored frequency exceeds a predetermined value, the above method may generate a battery performance deterioration event.

After step c), when the charging recovery of the battery is completed, the refreshing of the battery may be deactivated and the current accumulation value of the battery, the low SOC entering frequency, and the vehicle starting frequency may be reset.

In accordance with an exemplary embodiment of the present invention, the battery is advantageously reset and fully charged to maintain charging and discharging balance of the battery and improves the durable lifespan, in when condition information of the battery and the vehicle satisfies a predetermined condition that is necessary to refresh the battery. Further, the battery refresh results are arranged as data so that the battery durability deterioration conditions and the battery replacement timing are monitored.

In addition, when a hybrid vehicle (HEV) and an electric vehicle (EV) that use a high voltage battery as a driving energy source is applied to this invention, the capacity of the battery is prevented from being reduced and the durability of the battery is enhanced so that fuel consumption efficiency is increased and the quality of the vehicle is improved.

### BRIEF DESCRIPTION OF THE DRAWINGS

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

FIG. 1 is a graph showing a lifespan influence according to a charging/discharging characteristic of a conventional battery and of a battery in which the exemplary embodiment of the present invention is applied.

FIG. 2 is a block diagram showing a structure of a vehicle battery management system according to an exemplary embodiment of the present invention.

FIG. 3 is a flowchart showing a battery managing method of a battery management system according to an exemplary embodiment of the present invention.

FIG. 4 is a flowchart showing a battery charging recovery method according to an exemplary embodiment of the present invention.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DESCRIPTION OF SYMBOLS

100: battery management system

110: battery

120: battery observer

121: accumulated current measure module

122: low charging count module

130: alternator

140: generating amount observer

150: vehicle information collection portion

160: storage portion

170: control portion

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In overall specification, in addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function or operation, and can be implemented by hardware components or software components and combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a vehicle battery management system and a method thereof will be described in detail with reference to the accompanying drawings.

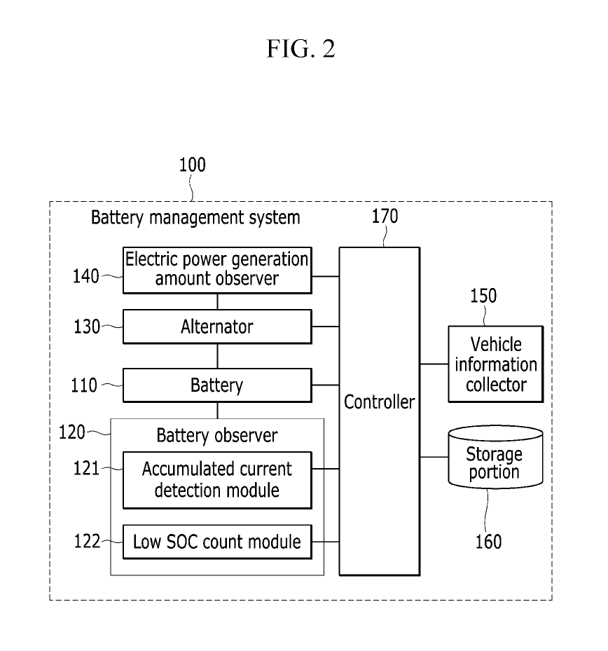

FIG. 2 is a block diagram showing a structure of a vehicle battery management system according to an exemplary embodiment of the present invention.

Referring to FIG. 2, a battery management system 100 according to an exemplary embodiment of the present invention includes a battery 110, a battery observer 120, an alternator 130, a generating amount observer 140, a vehicle information collection portion 150, a storage portion 160, and a control portion 170.

The battery 110 receives electrical power that is generated by the alternator 130 to store the electrical power therein, and the stored power may then be supplied to the electrical devices of the vehicle.

The battery observer 120 may be configured to detect battery condition information such as a battery voltage, a charging current, and a temperature of a battery, and includes an accumulated current measurement module 121 and a low charging count module 122. The accumulated current measure module 121 accumulates values of charged current and discharged current of the battery 110, and combines the two values to calculate the accumulation value of the charging and discharging current of the battery 110.

The low charging count module 122 detects the state of charge (SOC) of the battery 110, and counts the frequency of (the number of times) the battery 110 enters into a predetermined low state of charge (low SOC). Here, the term “low SOC” denotes that the charging rate (%) of the battery 110 is less than a predetermined threshold value.

The alternator 130 generates electrical power through driving torque of the vehicle and supplies the battery 110 and electrical devices of the vehicle with the generated power.

The generating amount observer 140 checks/monitors the voltage outputted from the alternator 130 and detects the generated electrical power amount.

The vehicle information collection portion 150 collects a vehicle speed and an engine RPM during the operation of the vehicle from related sensors. Also, the frequency of vehicle starts is counted and the accumulated frequency is stored to be managed in the storage portion 160, e.g., a memory, hard drive or other storage device.

The storage portion 160 stores all information for controlling the battery management system 100 and stores programs and the information that are generated during the control, and particularly stores all predetermined thresholds for activating refreshing the battery 110 and collected condition information of the vehicle and the battery.

The control portion 170 controls all portions for managing the battery of the vehicle. The control portion 170 receives the battery current accumulation value and a low SOC entry frequency from the battery observer 120, and receives the vehicle starting frequency from the vehicle information collection portion 150.

The control portion 170 determines whether the battery current accumulation value, the low SOC entry frequency, and the vehicle starting frequency satisfy a battery refresh condition. Here, a respective refresh condition for the battery current accumulation value (Ah), the low SOC entry frequency, and the vehicle starting frequency can be thresholds that are suitable for results that are calculated/selected by repeated experiments and tests.

The control portion 170 performs battery charging recovery until the battery is fully charged to prevent battery capacity reduction and to improve durability, when the determination result satisfies at least one of the battery refresh conditions.

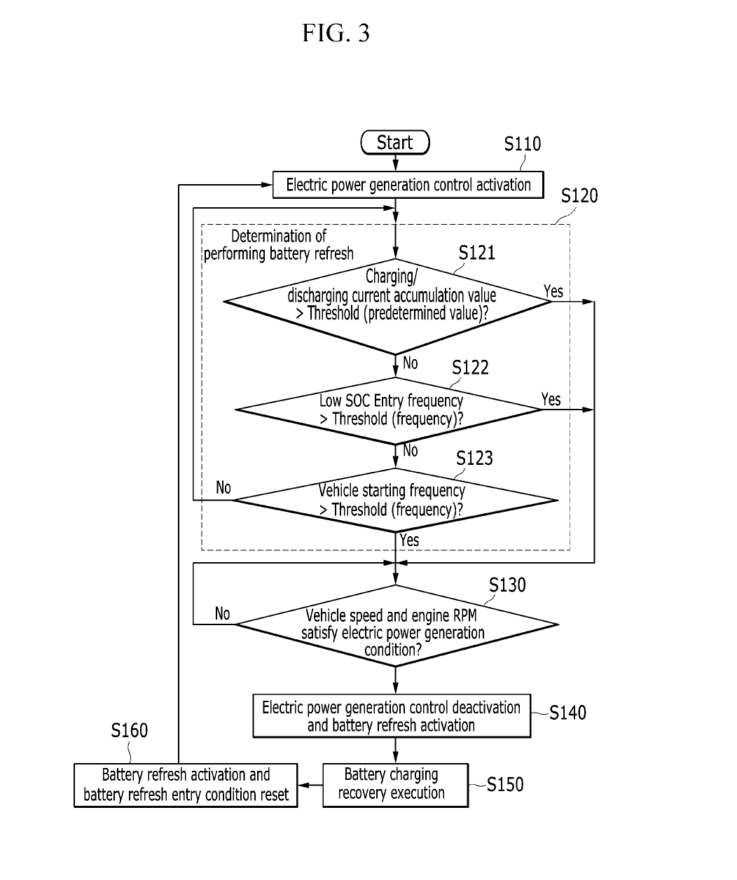

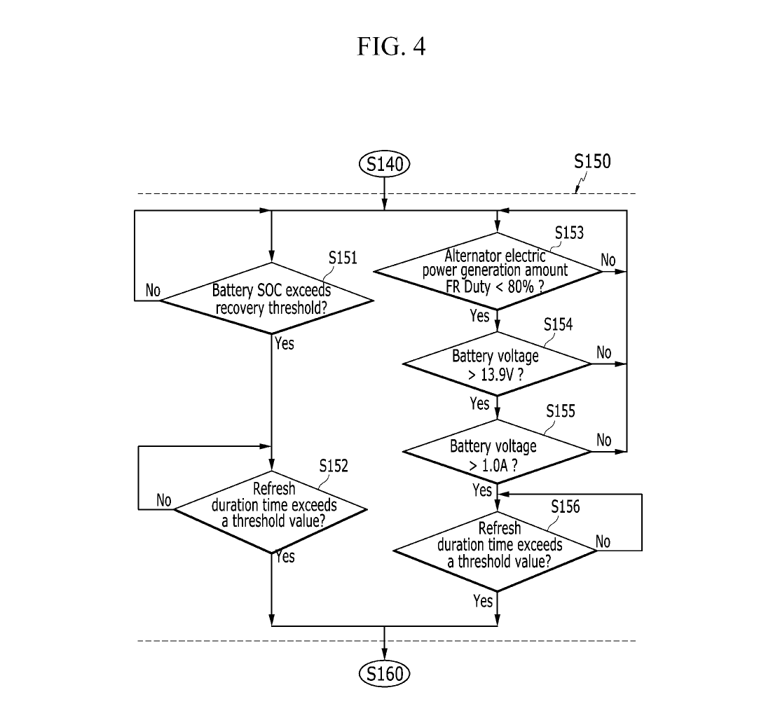

Meanwhile, referring to FIG. 3 and FIG. 4, a battery management method will be described through a refresh control method so as to secure durability of the battery management system 100 according to an exemplary embodiment of the present invention.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

FIG. 3 is a flowchart showing a battery managing method of a battery management system according to an exemplary embodiment of the present invention. Referring to FIG. 3, a vehicle battery management system 100 according to an exemplary embodiment of the present invention activates generation control for supplying electrical devices of the vehicle with electrical power, when the vehicle is started in step S110.

The battery management system 100 collects condition information of the vehicle and the battery, compares the collected information with the battery refresh entry condition, and determines whether the battery is refreshed or not in step S120.

First, when the current accumulation value of the battery being charged and discharged exceeds a predetermined threshold, the battery management system 100 determines that the refresh condition is satisfied in step S121. This is because the greater the current accumulation value at which the battery 110 is charged and discharged becomes, the shorter the battery durability would be.

Also, when the frequency of the state of charge (SOC) of the battery entering into a predetermined low SOC value exceeds a predetermined threshold, the battery management system 100 determines that the refresh condition is satisfied in step S122. This is because the larger the low SOC entry frequency of the battery 110 becomes, the smaller the SOH (state of health) of the battery becomes.

Also, the battery management system 100 determines that the refresh condition is satisfied, when the frequency for starting the vehicle exceeds a predetermined value in step S123. This is because the durability of the battery is reduced over time due to high current discharging of the battery 110.

Meanwhile, when the collected battery current accumulation value, the low SOC entry frequency, and the vehicle starting frequency are within predetermined threshold values, the battery management system 100 determines that the vehicle and the battery are in a normal condition and then continuously monitors whether the battery conditions satisfies refresh conditions (S121, S122, S123; No).

When the vehicle speed and the engine RPM satisfy predetermined conditions so that that the electricity can be generated in step S130, the battery management system 100 deactivates generation control and activates a battery refresh operation in step S140.

Here, the deactivating of the generation control includes breaking off or minimizing unnecessary power supply to the electrical devices in the vehicle, and limiting the battery supplying unnecessary electrical devices with electricity. Accordingly, the electrical power generated by the alternator 130 on the battery charging recovery is more accurately focused as a result.

The battery management system 100 performs the battery charging recovery until the generating amount of the alternator, the battery voltage, and the battery current value satisfy predetermined conditions in step S150. For example, the charging recovery of the battery signifies that the charging state of the battery (SOC) is greater than 95%, and can be performed for a predetermined time.

When the battery charging recovery is completed, the battery management system 100 deactivates the battery refresh operation and resets information necessary for determining that the battery satisfies refresh entry conditions in step S160, and the information is recorded by the respective detecting portions.

That is, the condition information of the vehicle and the battery including the battery current accumulation value, the low SOC entry frequency, and the vehicle starting frequency is reset and the generation control is activated.

Meanwhile, referring to FIG. 4, a battery charging recovery method will be explained in detail according to the battery refresh activation in step S150.

FIG. 4 is a flowchart showing a battery charging recovery method according to an exemplary embodiment of the present invention. Referring to FIG. 4, the battery management system 100 according to an exemplary embodiment of the present invention supplies the electrical power that is generated by the alternator 130 to the battery 110 to perform the battery charging recovery.

The battery management system 100 determines that the battery is fully charged when the SOC of the battery exceeds a recovery threshold (for example, SOC>95%) in step S151, and the battery management system 100 deactivates the battery charging recovery when the refresh continuation time exceeds a predetermined time (for example, two hours) in step S152.

Also, when the refresh duration time exceeds a predetermined value (for example, two hours) in a condition in which the generating amount of the alternator 130, the battery voltage, and the battery charging current value respectively satisfy predetermined conditions (S153, S154, S155), the battery management system 100 deactivates the battery charging recovery (S156) and resets the information that is used to determine whether the battery has entered into the battery refresh condition in step S160, although the charging condition of the battery does not satisfy the recovery condition, (i.e., the battery is not fully charged) (S151; No).

Here, the S151 and S152 steps are used to release the refresh operation when the battery 110 is fully charged to e.g., greater than 95% (SOC) through the battery charging recovery operation, and the S143 to S145 steps are used to release the refresh operation after a predetermined time, although the battery 110 is not fully charged and is at, e.g., less than 95% (SOC).

As such, the battery management system 100 according to an exemplary embodiment of the present invention resets and fully charges the battery to maintain charging and discharging balance and to improve the durable lifespan, in a condition that the current accumulation amount according to the charging and the discharging of the battery, the low SOC entry frequency, and the vehicle starting frequency in which a large amount of current is used satisfy a predetermined condition for refreshing the battery.

Also, in a case that a hybrid vehicle (HEV) and an electric vehicle (EV) that use a high voltage battery as a driving energy source is applied to this invention, the reduction of capacity of the battery is prevented and the durability of the battery is enhanced such that fuel consumption efficiency is increased and the quality of the vehicle is enhanced.

Thus far, exemplary embodiments of the present invention have been explained, but the present invention is not limited to the exemplary embodiments, and this invention can also be used to diagnose the replacement timing of the battery. For example, after the S153 to S155 steps are performed in an exemplary embodiment of the present invention shown in the FIG. 4, the number of cases that the battery is not fully charged is counted and recorded. And, when the counted frequency of the battery, which is not fully charged by the refresh result, exceeds a predetermined value, a battery performance deterioration event is generated. Thereby, the battery refresh results are arranged as data such that there is a merit that a battery durability deterioration condition or battery replacement timing is displayed through a vehicle display.

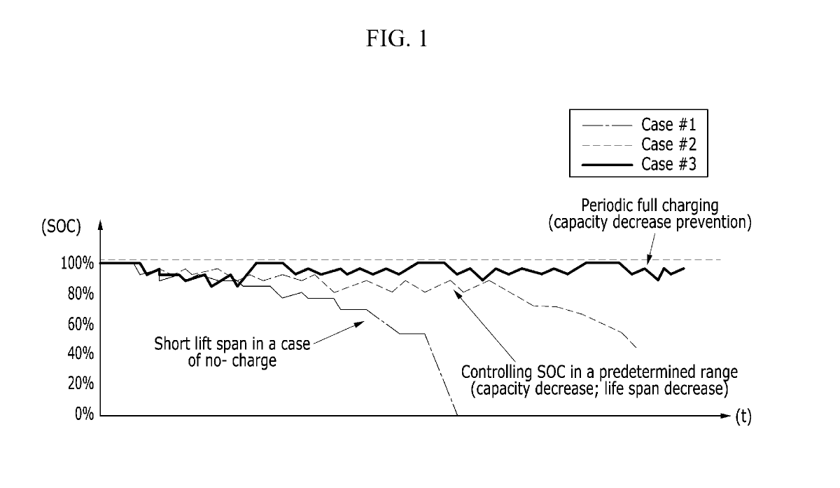

Advantageously, as can be seen in FIG. 1, Case #3 shows a condition in which the battery is periodically fully charged and the charging/discharging balance and charging efficiency are suitably managed to prevent the capacity reduction of the battery.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vehicle battery management system, comprising:
an alternator configured to supply a battery and electronic equipment of a vehicle with electricity that is generated by a driving torque of the vehicle;
a battery configured to supply the electronic equipment with power that is charged by the alternator;
a battery observer configured to monitor a condition of the battery;
a vehicle information collection portion configured to collect vehicle condition information based on driving conditions of the vehicle; and
a control portion configured to perform charging recovery of the battery by activating a battery refresh operation when at least one condition of a current accumulation value of the battery, a low SCO entry frequency, and a vehicle starting frequency satisfies a predetermined battery refresh condition.

2. The vehicle battery management system of claim 1, further comprising a storage portion configured to store a predetermined threshold condition and condition information of the vehicle and the battery to determine whether the battery satisfies a refresh condition.

3. The vehicle battery management system of claim 1, wherein the battery observer includes at least one of:
an accumulation current measure module configured to accumulate values of charged current and discharged current of the battery to calculate a current accumulation value of the charged current and the discharged current; and
a low SOC counter module configured to monitor an SOC (state of charge) of the battery and counts a frequency of the charging state of the battery entering into a predetermined low charging state (low SOC).

4. The vehicle battery management system of claim 3, wherein the vehicle information collection portion collects a vehicle speed and an engine revolution per minute (RPM) according to the operation of the vehicle and counts the starting frequency of the vehicle.

5. The vehicle battery management system of claim 1, wherein the control portion deactivates generating control when the battery enters the charging state, and the electricity that is generated by the alternator is entirely focused on the battery charging recovery.

6. The vehicle battery management system of claim 1, wherein the control portion performs the charging recovery until the charging state of the battery exceeds a predetermined recovery threshold.

7. The vehicle battery management system of claim 1, wherein the control portion performs the charging recovery of the battery for a predetermined time when an amount of power generated by the alternator, the battery voltage, and the battery current value satisfy the predetermined conditions.

8. The vehicle battery management system of claim 1, wherein the control portion deactivates the battery refresh operation when the charging recovery of the battery is completed, and then resets the battery current accumulation value, the low SOC entry frequency, and the vehicle starting frequency.

9. A vehicle battery management method that is performed by a system that includes an alternator of a vehicle, a battery, and a control portion managing a charging state of the battery, comprising:
a) collecting, by a controller, condition information of the vehicle and a condition of the battery;
b) determining, by the controller, whether at least one condition of a current accumulation value of the battery, a low SCO entry frequency, and a vehicle starting frequency satisfies a predetermined battery refresh condition; and
c) performing, by the controller, charging recovery of the battery by activating the battery refresh operation, when the determination result satisfies the battery refresh condition.

10. The vehicle battery management method of claim 9, wherein the b) step includes:
b-1) determining that the refresh condition is satisfied when the current accumulation value of the charging and discharging current of the battery exceeds a predetermined value;
b-2) determining that the refresh operating condition is satisfied in a case that the frequency of entering into a lowest SOC of the battery exceeds a predetermined threshold; and
b-3) determining that that the refresh operating condition is satisfied in a case that the starting frequency of the vehicle exceeds a predetermined threshold.

11. The vehicle battery management method of claim 9 wherein the c) step includes
deactivating the generation control and activating the battery refresh when the vehicle speed and the engine RPM satisfy a predetermined condition at which the alternator can generate electricity.

12. The vehicle battery management method of claim 9, wherein the c) step includes
operating the charging recovery until the charging state of the battery exceeds a predetermined recovery threshold, or
performing the charging recovery of the battery for a predetermined time in a condition in which an amount power generated by the alternator, battery voltage, and battery current value satisfy a predetermined condition.

13. The vehicle battery management method of claim 12, wherein after the c) step, the frequency at which the refresh performance result of the battery does not exceed a recovery threshold is counted to be stored, and when the stored frequency exceeds a predetermined value, generating a battery performance deterioration event.

14. The vehicle battery management method of claim 9, wherein after the c) step, when the charging recovery of the battery is completed, the refreshing of the battery is deactivated and the current accumulation value of the battery, the low SOC entering frequency, and the vehicle starting frequency are reset.

15. A non-transitory computer readable medium containing program instructions executed by a processor or controller, the computer readable medium comprising:
program instructions that collect condition information of the vehicle and a condition of the battery;
program instructions that determine at least one condition of a current accumulation value of the battery, a low SCO entry frequency, and a vehicle starting frequency satisfies a predetermined battery refresh condition; and
program instructions that perform charging recovery of the battery by activating the battery refresh operation, when the determination result satisfies the battery refresh condition.
